(19) United States
(12) Patent Application Publication
(10) Pub. No.: US 2016/0011799 A1
(43) Pub. Date: Jan. 14, 2016

(54) SOLID STATE DISK DEVICE

(71) Applicant: NEXCOM INTERNATIONAL CO., LTD., New Taipei City (TW)

(72) Inventor: Wen-Lang Yu, Taipei City (TW)

(21) Appl. No.: 14/505,505

(22) Filed: Oct. 3, 2014

(30) Foreign Application Priority Data
Jul. 8, 2014 (TW) 103123505

(51) Int. Cl. G06F 3/06

(52) U.S. Cl. CPC G06F 3/0616; G06F 3/0653; G06F 3/0659; G06F 3/0688

(57) ABSTRACT

A solid state disk (SSD) device includes a random access memory (RAM), a flash memory array, a main power receiving component and a control unit. When a file to be written is not larger than a threshold capacity of the RAM, the file is stored in the RAM; otherwise the file is stored to the flash memory array. When a main power supply stops providing power to the main power receiving component, the control unit moves data stored in the RAM to the flash memory array.

### BACKGROUND OF THE INVENTION

1. Field of the Invention

The present invention relates to a solid state disk (SSD) device, and more particularly, an SSD device in which the storage location of a file is determined by the size of the file.

2. Description of the Prior Art

There are two types of flash memory: NAND flash memory (hereinafter referred to as NAND flash) and NOR flash memory (hereinafter referred to as NOR flash), which are named after the NAND and NOR logic gates. Their features are described below.

(a) NOR flash: Internal addresses in a NOR flash are continuously arranged so that a NOR flash is suitable for storing program codes and is allowed to perform execute-in-space (XIP), which means to execute programs directly on a NOR flash without copying the code to a RAM. However, the structure of a NOR flash is complicated, and the cost of production is high. The capacity is therefore limited so that a NOR flash is not suitable to store a large file, for example, a file larger than 16 Megabytes (MB).
(b) NAND flash: With simpler structure for production, larger capacity for storage per unit area, and faster speed of writing and erasing, a NAND flash is more suitable for high capacity data storage than a NOR flash. Therefore, a solid storage data (SSD) is usually implemented with an NAND flash memory array. There are three types of NAND flash: (1) the single-level cell (SLC) type; (2) the multi-level cell (MLC) type; and the triple-level cell (TLC) type. An SLC type of NAND flash cell may endure 100,000 times of writings typically, a MLC type of NAND flash cell may endure 10,000 times of writings typically, and a TLC type of NAND flash cell may endure 1,000 times of writings typically. It may lead to memory cell damage or failure in storing data to write data to a flash memory cell after exceeding the limited number of times of writings.

For extending the lifetime of an SSD device, two techniques are used according to the prior art:

### (1) Wear-Leveling Technique:

An SSD device with wear-leveling technique is managed with a software algorithm for allocating memory areas to be written averagely in a flash memory array so as to prevent that the SSD device from failing early because some areas have been written many times and reach the lifetime limit while some other areas are seldom written. By using wear-leveling technique, the lifetime of an SSD device is optimized by accessing each disk sector in an SSD device more averagely.

### (2) File Comparison Storage Technique:

File comparison storage technique is also a software management technique. Before storing a file to an SSD device, a controller compares the file with files stored in the SSD device, and the file is not stored to the SSD device if the file is determined to be identical to a file stored in the SSD device. The number of times of writing is hence reduced so as to extend the lifetime of a flash memory.

The enhancement of the lifetime of an SSD device made by using the abovementioned two software management techniques is quite limited. Wear-leveling technique merely arranges all sectors in a flash memory to be written averagely for the SSD device not to fail in early life. The effect of file comparison storage technique is even more limited. File comparison storage technique only prevents the same files from being stored. However, the probability of storing an identical file to an SSD device repeatedly is not high, and even so, the different writing times provide meaningful system information. For example, an event is recorded in a log file when writing an identical file to an SSD device. However, using file comparison storage technique may lead to incorrect records in the log file because the writing of an identical file is not correctly recorded. Furthermore, the abovementioned two techniques require a controller to perform hard disk sector management, writing/reading/erasing cycle management and memory garbage collection (GC) so that the loading of the controller is inefficiently increased. Therefore, the described two techniques for extending the lifetime of an SSD device by using software management both have shortcomings.

### SUMMARY OF THE INVENTION

An embodiment of the present invention discloses a solid state disk (SSD) device. The SSD device comprises a random access memory (RAM), a flash memory array, a control unit, an interface component, a main power receiving component and a backup power supply. The control unit is coupled to the RAM and the flash memory array, and the control unit comprises firmware configured to execute instructions of a computer system for accessing data of the RAM and the flash memory array. The interface component is coupled to the control unit and the computer system, and configured to receive the instructions of the computer system. The main power receiving component is coupled to the control unit, the interface component, the RAM and the flash memory array, and configured to receive power from a main power supply so as to provide power to the control unit, the interface component, the RAM and the flash memory array. The backup power supply is coupled to the main power receiving component, the control unit, the RAM and the flash memory array, and configured to be charged by the main power supply when the main power receiving component receives power from the main power supply, and provide power to the control unit, the RAM and the flash memory array when the main power receiving component stops receiving power from the main power supply. When the interface component receives a writing instruction from the computer system, a file is written to the flash memory array if the file is larger than a threshold capacity of the RAM, otherwise the file is written to the RAM; and the control unit reads data stored in the RAM and writes the data stored in the RAM to the flash memory array when the main power supply stops providing power.

Another embodiment of the present invention discloses a solid state disk (SSD) device. The SSD device comprises a random access memory (RAM), a flash memory array, a control unit, an interface component and a main power receiving component. The control unit is coupled to the RAM and the flash memory array, comprising firmware configured to execute instructions of a computer system for accessing data of the RAM and the flash memory array. The interface component is coupled to the control unit and the computer system, and configured to receive the instructions of the computer system. The main power receiving component is coupled to the control unit, the interface component, the RAM and the flash memory array, and configured to receive power from a main power supply so as to provide power to the control unit, the interface component, the RAM and the flash memory array. When the interface component receives a writing instruction from the computer system, a file is written to the flash memory array if the file is larger than a threshold capacity of the RAM, otherwise the file is written to the RAM; and a time period before the main power supply stops providing power, the computer system sends a shutdown instruction to the control unit through the interface component to enable the control unit to read data stored in the RAM and write the data stored in the RAM to the flash memory array.

Another embodiment of the present invention discloses a solid state disk (SSD) device control method. The SSD device comprises a random access memory (RAM), a flash memory array, an interface component, a main power receiving component and a backup power supply. The method comprises: determining whether a file is larger than a threshold capacity of the RAM when writing the file to the SSD device through the interface component and the main power receiving component receives power from a main power supply; writing the file to the RAM if the file is not larger than the threshold capacity; and reading the file from the RAM and writing the file to the flash memory array when the main power supply stops providing power and the backup power supply provides power to the RAM and the flash memory array.

Another embodiment of the present invention discloses a solid state disk (SSD) device control method. The SSD device comprises a random access memory (RAM), a flash memory array, an interface component and a main power receiving component. The method comprises: determining whether a file is larger than a threshold capacity of the RAM when writing the file to the SSD device through the interface component and the main power receiving component receives power from a main power supply; writing the file to the RAM if the file is not larger than the threshold capacity; reading the file from the RAM and writing the file to the flash memory array when receiving a shutdown instruction through the interface component; and the main power supply stopping providing power to the main power receiving component.

Another embodiment of the present invention discloses a solid state disk (SSD) device control method. The SSD device comprises a random access memory (RAM), a flash memory array, an interface component and a main power receiving component. The method comprises determining whether a file is larger than a threshold capacity of the RAM when writing the file to the SSD device through the interface component and the main power receiving component receives power from a main power supply; and writing the file to the flash memory array if the file is larger than the threshold capacity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an SSD device according to an embodiment of the present invention.

FIG. 2 illustrates an SSD device according to another embodiment of the present invention.

FIG. 3 illustrates an SSD device control method corresponding to the SSD devices shown in FIG. 1 and FIG. 2.

FIG. 4 illustrates an SSD device according to another embodiment of the present invention.

FIG. 5 illustrates an SSD device control method corresponding to the SSD device shown in FIG. 4.

FIG. 6 illustrates an SSD device according to another embodiment of the present invention.

### DETAILED DESCRIPTION

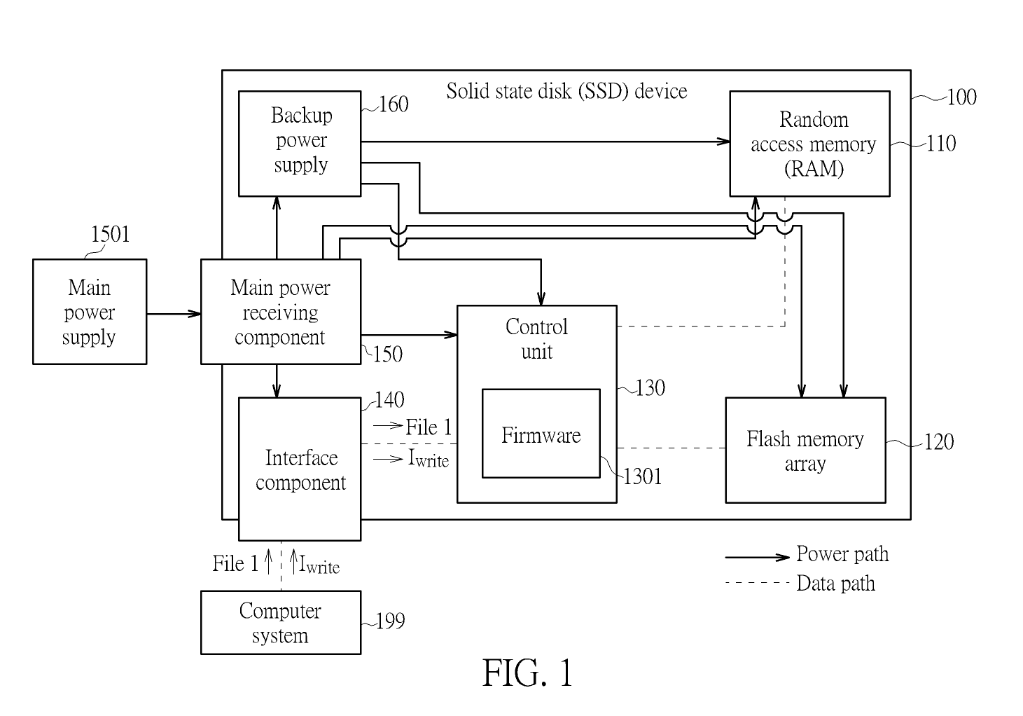

FIG. 1 illustrates an SSD device 100 according to an embodiment of the present invention. The SSD device 100 includes a random access memory (RAM) 110, a flash memory array 120, a control unit 130, an interface component 140, a main power receiving component 150 and a backup power supply 160. The control unit 130 is coupled to the RAM 110 and the flash memory array 120. The control unit 130 includes firmware 1301 for executing instructions of a computer system 199 for accessing data of the RAM 110 and the flash memory array 120. The interface component 140 is coupled to the control unit 130 and the computer system 199 for receiving the instructions of the computer system 199. The main power receiving component 150 is coupled to the control unit 130, the interface component 140, the RAM 110 and the flash memory array 120, and configured to receive power from a main power supply 1501 so as to provide power to the control unit 130, the interface component 140, the RAM 110 and the flash memory array 120. The backup power supply 160 is coupled to the main power receiving component 150, the control unit 130, the RAM 110 and the flash memory array 120, and configured to be charged by the main power supply 1501 when the main power receiving component 150 receives power from the main power supply 1501, and provide power to the control unit 130, the RAM 110 and the flash memory array 120 when the main power receiving component 150 stops receiving power from the main power supply 1501. When the interface component 140 receives a writing instruction I_{write} from the computer system 199, a file File1 is written to the flash memory array 120 if the file File1 is larger than a threshold capacity of the RAM 110; otherwise the file File1 is written to the RAM 110. The control unit 130 reads data stored in the RAM 110 and writes the data stored in the RAM 110 to the flash memory array 120 when the main power supply 1501 stops providing power. In FIG. 1, the dotted lines are electrical power paths for describing the transmission of power, and the solid lines are data paths for describing the transmission of file data and instruction signals.

The RAM 110 in FIG. 1 may be implemented with dynamic random access memory (DRAM), synchronous dynamic random access memory (SDRAM), double data rate synchronous dynamic random access memory (DDR SDRAM), double data rate second generation synchronous dynamic random access memory (DDR2 SDRAM), double data rate third generation synchronous dynamic random access memory (DDR3 SDRAM) or double data rate fourth generation synchronous dynamic random access memory (DDR4 SDRAM). According to the embodiment of the present invention, the file File1 is checked by the control unit 130 before being stored in the flash memory array 120 and the operation is performed according to the following Table 1:

TABLE 1

| The conditions corresponding to the | | |
|---|---|---|
| results of the checking performed by the | | |
| control unit 130 | | Corresponding operation |
| The main | The file File1 written to | The control unit 130 |
| power | the SSD device 100 is not | stores the file File1 in |
| receiving | larger than a threshold | the RAM 110. |
| component | capacity of the RAM 110. | |
| 150 receives | The file File1 written to | The control unit 130 |
| power from | the SSD device 100 is | stores the file File1 in |
| the main | larger than the threshold | the flash memory array |
| power supply | capacity of the RAM 110. | 120. |
| 1501. | | |

| | |
|---|---|
| The main power receiving component | The control unit 130 |
| stops receiving power from the main | performs an off-line |
| power supply 1501. | writing operation to move |
| | a portion of data or all |
| | data stored in the RAM 110 |
| | to the flash memory array |
| | 120. |

Different from the prior art, the lifetime of the flash memory array 120 of the SSD device 110 is not extended by using software management techniques. Another technique described in the above Table 1 is used according to an embodiment of the present invention. Files with smaller size are not directly stored in the flash memory array 120 so that the number of times of accessing the flash memory array 120 is reduced by a hardware solution. The backup power supply 160 is used to provide power for moving data stored in the RAM 110 to the flash memory array 120 when the main power supply 1501 stops providing power to the main power receiving component 150. For example, when a whole computer system is turned off and shut down. For instance, if the RAM 110 has a 1024 megabytes (MB) storage capacity, the RAM 110 is used for the computer system 199 to write or read files with smaller sizes. The following Table 2 shows a conceptual example:

TABLE 2

| The | | |
|---|---|---|
| operation | | |
| intended | The corresponding | |
| to | operation according | The corresponding operation |
| perform | to the wear-leveling | according to an embodiment of the |
| on the SSD | technique of the | present invention with a RAM 110 |
| device | prior art | having a 1024 MB storage capacity |
| Writing a | Writing the 1^{st} file | Writing the 1^{st} file to the RAM 110 |
| 1^{st} file | to the flash memory | so that the threshold capacity of |
| with a | array | the RAM 110 is 724 MB (= 1024 |
| size of | | MB − 300 MB) |
| 300 MB | | |
| Writing a | Writing the 2^{nd} file | Writing the 2^{nd} file to the RAM 110 |
| 2^{nd} file | to the flash memory | so that the threshold capacity of |
| with a | array | the RAM 110 is 324 MB (= 724 |
| size of | | MB − 400 MB) |
| 400 MB | | |
| Writing a | Writing the 3^{rd} file | Writing the 3^{rd} file to the RAM 110 |
| 3^{rd} file | to the flash memory | so that the threshold capacity of |
| with a | array | the RAM 110 is 224 MB (= 324 |
| size of | | MB − 100 MB) |
| 100 MB | | |
| Deleting | Deleting the 1^{st} file | Deleting the 1^{st} file from the RAM |
| the 1^{st} | from the flash memory | 110 so that the threshold |
| file | array | capacity of the RAM 110 is 524 MB |
| | | (= 224 MB + 300 MB) |
| Writing a | Writing the 4^{th} file | Writing the 4^{th} file to the flash |
| 4^{th} file | to the flash memory | memory array 120 since the 4^{th} |
| with a | array | file with a file size (600 MB) |
| size of | | larger than the threshold |
| 600 MB | | capacity (524 MB) |
| Deleting | Deleting the 2^{nd} file | Deleting the 2^{nd} file from the RAM |
| the 2^{nd} | from the flash memory | 110 so that the threshold |
| file | array | capacity of the RAM 110 is 924 MB |
| | | (= 524 MB + 400 MB) |
| Shutting | No corresponding | The backup power supply 160 |
| down the | operation performed | providing power to the control |
| computer | | unit 130 for moving the 3^{rd} file |
| so that | | stored in the RAM 110 to the flash |
| the main | | memory array 120 |
| power | | |
| supply | | |
| stops | | |
| providing | | |
| power to | | |
| the SSD | | |
| device | | |
| The | 4 | 2 (merely half of the required |
| number of | | number of the prior art) |
| times of | | |
| writing | | |
| data to | | |
| the flash | | |
| memory | | |
| array | | |

As described with the example shown in Table 2, it is unnecessary to write every file to the flash memory array 120 when writing data to the SSD device 110 according to an embodiment of the present invention. A file may be written to the RAM 110 and deleted before being stored in the flash memory array 120 so that the file may be never written to the flash memory array 120. Therefore, the number of times of writing data to the flash memory array 120 is reduced, and the lifetime of the flash memory array 120 is extended. The example shown in Table 2 is merely a simplified example for demonstrating the present invention. In general, files written to an SSD device (e.g. the SSD device 100 of FIG. 1) have smaller sizes rather than large files such as the 1^{st} file to the 4^{th} file with file size of hundreds MB shown in the example of Table 2, so the reduced number of times of writing data to the flash memory array 120 may be much greater. Take system files generated during the operation of an operating system (OS) for example. Most of the system files may have small file sizes such as several kilobytes (KB) to MB, and are frequently generated, updated and deleted. All system files need to be written to a flash memory array in the prior art, so that the number of times for accessing data to the flash memory array is greatly increased, and the number of times for accessing data to the flash memory array may be substantially decreased according to the present invention.

According to the embodiment of described above, the threshold capacity of the RAM 110 may be defined by the following four ways.

(1) The threshold capacity may be defined as an available capacity of the RAM 110. For example, if the RAM 110 has an available capacity of 1000 MB, the threshold capacity of the RAM 110 can be defined as 1000 MB. After writing a file with a size of 400 MB to the RAM 110, the threshold capacity is reduced to be (1000 MB-400 MB), that is 600 MB.
(2) The threshold capacity may be defined as a proportion of the available capacity of the RAM 110. For instance, when the available capacity of the RAM 110 is 1000 MB, and the proportion of the threshold capacity to the available capacity is set to be 80%, the said threshold capacity of the RAM 110 is 800 MB (=1000 MB×80%). After writing 400 MB data in the RAM 110, the available capacity remains 600 MB (=1000 MB−400 MB), so the threshold capacity becomes (600 MB×80%), that is 480 MB. The said proportion may be set in the firmware 1301 for the control unit 130 to calculate the threshold capacity, and the proportion may be adjusted when updating the firmware.
(3) The threshold capacity may be calculated by subtracting a reserved capacity from the available capacity. For example, if the available capacity of the RAM 110 is 1000 MB and the reserved capacity is set as 100 MB, the threshold capacity is (1000 MB−100 MB), that is 900 MB. The reserved capacity may be set in the firmware 1301 for the control unit 130 to calculate the threshold capacity, and the reserved capacity may be adjusted when updating the firmware.
(4) The threshold capacity may be an output of a mathematical function taking an available capacity of the RAM 110 as an input. For example, if the available capacity of the RAM 110 is 1000 MB, and the function is:

the threshold capacity=(the available capacity−100 MB)×80% (α);

when booting the computer system 199, the threshold capacity is (1000 MB−100 MB)×80%, that is 720 MB. After writing 400 MB data in the RAM 110, the threshold capacity is (1000 MB−400 MB−100 MB)×80%, that is 400 MB. The abovementioned function (α) is taken as an example rather than limiting the present invention.

According to an embodiment of the present invention, when the threshold capacity of the RAM 110 is reduced to be a lower-limited value (e.g. 5 MB), the control unit 130 moves all data or a portion of data stored in the RAM 110 to the flash memory array 120.

Regarding FIG. 1, the control unit 130 may be a control unit including a microprocessor, a microcontroller unit (MCU) and/or an integrated circuit (IC), with firmware installed inside to receive instructions, perform determinations, and control the RAM 110 and the flash memory array 120. The control unit 130 shown in FIG. 1 may also comprise a path for transferring data for the computer system 199 to write data to the RAM 110 or the flash memory array 120, or for data from the RAM 110 to be transferred through to the flash memory array 120 when performing the off-line writing operation. The interface component 140 acts as an interface for receiving data and instructions from the computer system 199, and the interface component 140 may be a universal serial bus (USB) interface or a serial ATA (SATA) interface. When writing data to the SSD device 100, the computer system 199 sends an instruction to the control unit 130 through the interface component 140, and the control unit 130 identifies the received instruction is the writing instruction I_{write} so as to perform the abovementioned determination and operation for writing data to the SSD device 110. The type of the main power receiving component 150 is determined according to the specification of the SSD device 110. For example, the main power receiving component 150 may be a 4-pin Molex power connector used to receive power. The flash memory array 120 may be formed with multiple MLC (multi-level cell) flash memory cells, multiple SLC (single-level cell) flash memory cells or multiple TLC (triple-level cell) flash memory cells.

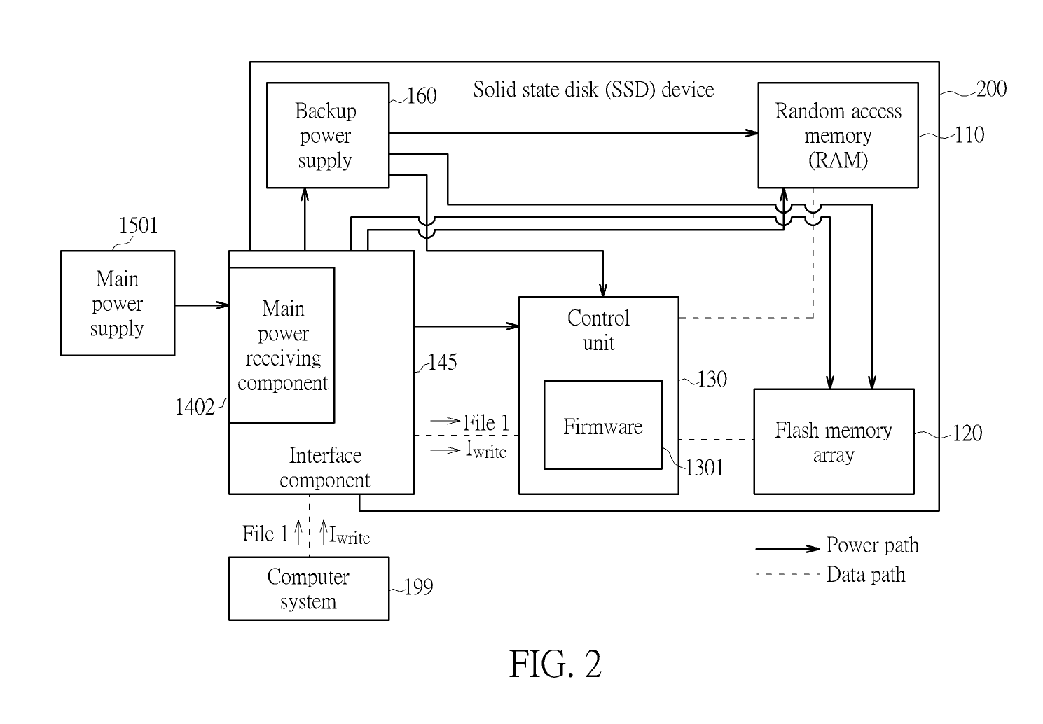

FIG. 2 illustrates an SSD device 200 according to another embodiment of the present invention. Regarding FIG. 2, the RAM 110, flash memory array 120, the control unit 130, the interface component 145 and the backup power supply 160 of the SSD device 220 are not described again since they operate in the same way as in FIG. 1. The difference between the SSD devices 100 and 200 is that the main power receiving component 1402 is embedded in the interface component 145 of the SSD device 200 so that the interface component 145 may be used for receiving power from the main power supply 1501 and instructions (e.g. the writing instruction I_{write}) and data (e.g. the file File1) from the computer system 199. The interface component 145 may be a USB interface, an SCSI interface or an SATA interface used for transferring both power and data. The mentioned SATA interface may include a data transferring connect and a power transferring connect, and the mentioned USB interface may be a single connect comprising some pins for transferring data and some other pins for transferring power.

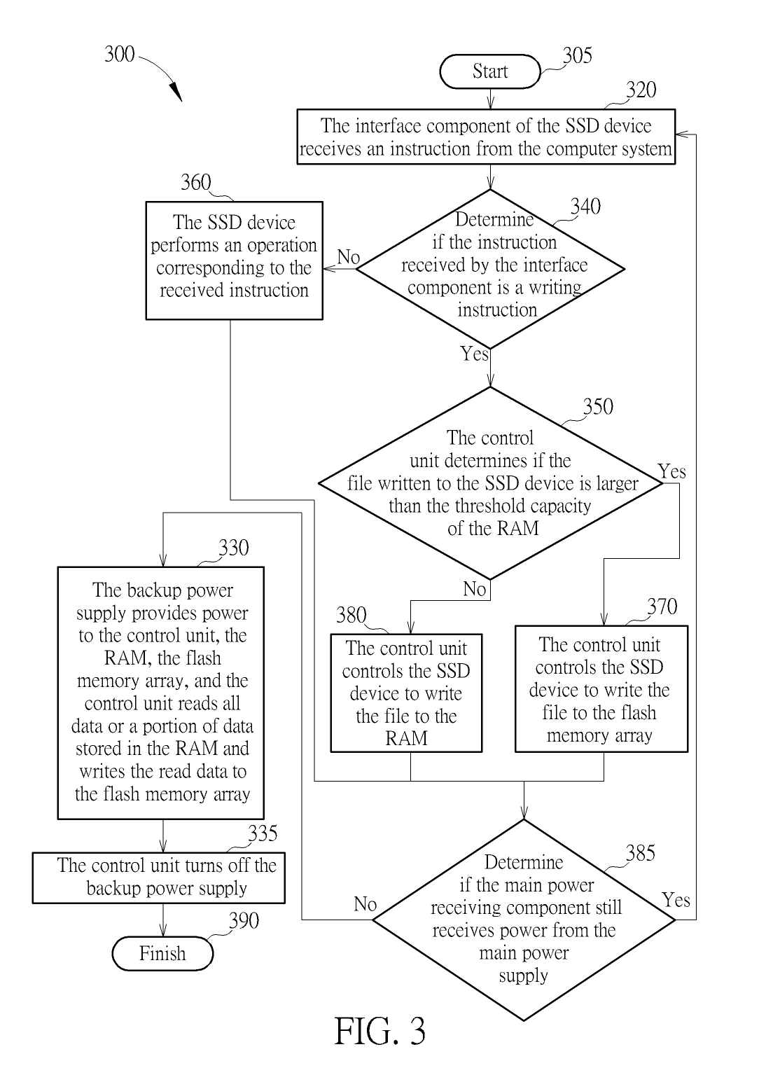

FIG. 3 illustrates an SSD device control method 300 corresponding to the SSD devices 100 and 200. The method 300 includes the following steps:

Step 305: start;

Step 320: the interface component 140 of the SSD device 100 receives an instruction from the computer system 199, enter step 340;

Step 340: determine if the instruction received by the interface component 140 is a writing instruction I_{write}. If yes, enter step 350; if no, enter step 360;

Step 350: the control unit 130 determines if the file File1 written to the SSD device 100 is larger than the threshold capacity of the RAM 110. If yes, enter step 370; if no, enter step 380;

Step 360: the SSD device 100 performs an operation corresponding to the received instruction; enter step 385;

Step 370: the control unit 130 controls the SSD device 100 to write the file File1 to the flash memory array 120; enter step 385;

Step 380: the control unit 130 controls the SSD device 100 to write the file File1 to the RAM 110; enter step 385;

Step 385: determine if the main power receiving component 150 still receives power from the main power supply 1501. If yes, enter step 320; if no, enter step 330;

Step 330: the backup power supply 160 provides power to the control unit 130, the RAM 110, the flash memory array 120, and the control unit 130 reads all data or a portion of data stored in the RAM 110 and writes the read data to the flash memory array 120; enter step 335;

Step 335: the control unit 130 turns off the backup power supply 160; enter step 390; and

Step 390: Finish.

In the abovementioned step 385, if the main power receiving component 150 still receives power from the main power supply 1501, the backup power supply 160 is charged by the main power supply 1501 through the main power receiving component 150 so that the backup power supply 160 is able to provide power to the control unit 130, the RAM 110, and the flash memory array 120 when the main power receiving component 150 stops receiving power from the main power supply 1501, for example, when the computer system 199 is being shut down. In steps 340, 350 and 360, if the instruction received by the interface component 140 is the writing instruction I_{write} it is determined that the computer system 199 writes the file File1 to the SSD device 100; and if the received instruction is not the writing instruction I_{write}, the instruction may be a read instruction, a delete instruction or a copy instruction, and a corresponding operation is performed in step 360. The above described method 300 is explained by referring to the SSD device 100 shown in FIG. 1. However, since the structure of the SSD device 200 of FIG. 2 is identical to the SSD device 100 except that the main power receiving component 1402 is embedded into the interface component 145, the method 300 is allowed to be applied on the SSD device 200.

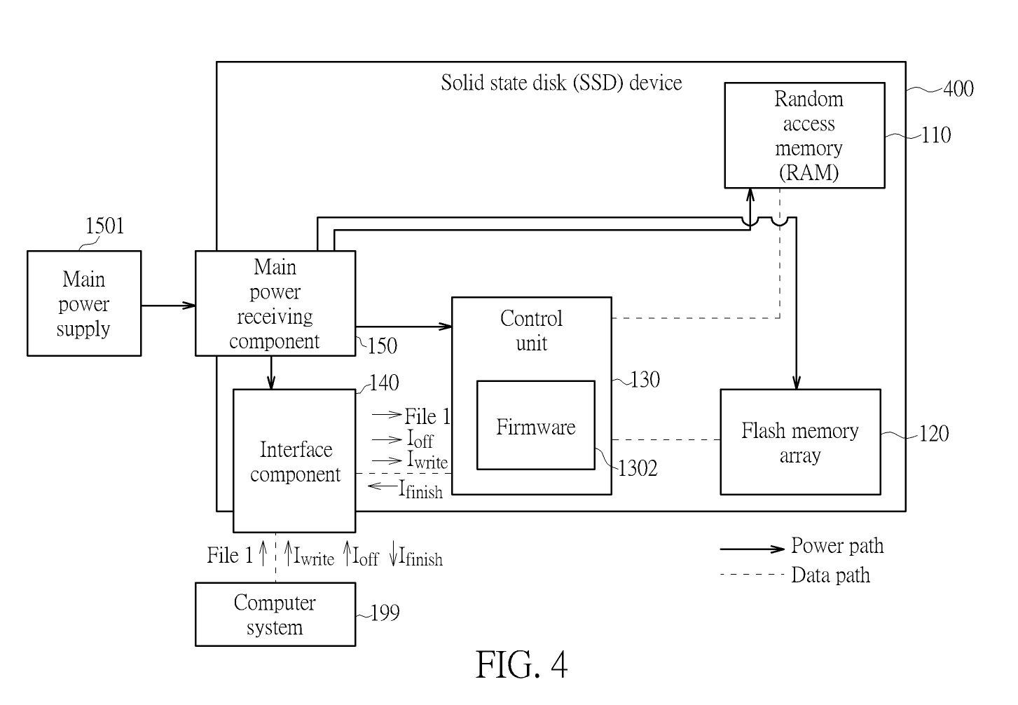

FIG. 4 illustrates an SSD device 400 according to another embodiment of the present invention. The SSD device 400 is similar to the SSD device 100 shown in FIG. 1 so as to include the RAM 110, the flash memory array 120, the control unit 130, the interface component 150 and the main power receiving component 150. These components and units are described above, so the related description is not repeated. Comparing with the SSD device 100, the SSD device 400 does not include the backup power supply 160. When the computer system 199 writes the file File1 to the SSD device 400, the operation steps on the SSD device 400 are similar to the operation steps on the SSD device 100. That is, when the interface component receives the writing instruction I_{write} from the computer system 199, the file File1 is written to the RAM 110 if the file File1 is not larger than the threshold capacity of the RAM 110, otherwise the file File1 larger than the threshold capacity is written to the flash memory array 120. However, before the main power supply 1501 stops providing power to the main power supply component 150, the computer system 199 sends a shutdown instruction I_{off} to the control unit 130 through the interface component 140 so as to inform the control unit 130 to read all data or a portion of data stored in the RAM 110 for writing to the flash memory array 120. For example, when a user performs a shutdown operation in an operating system, such as pushing the “Start” button and then pushing the “Shut down” button in a Microsoft® Windows environment, the computer system 199 of FIG. 4 sends the shutdown instruction I_{off} to the control unit 130 for executing the firmware 1302 to move the data stored in the RAM 110 to the flash memory 120.

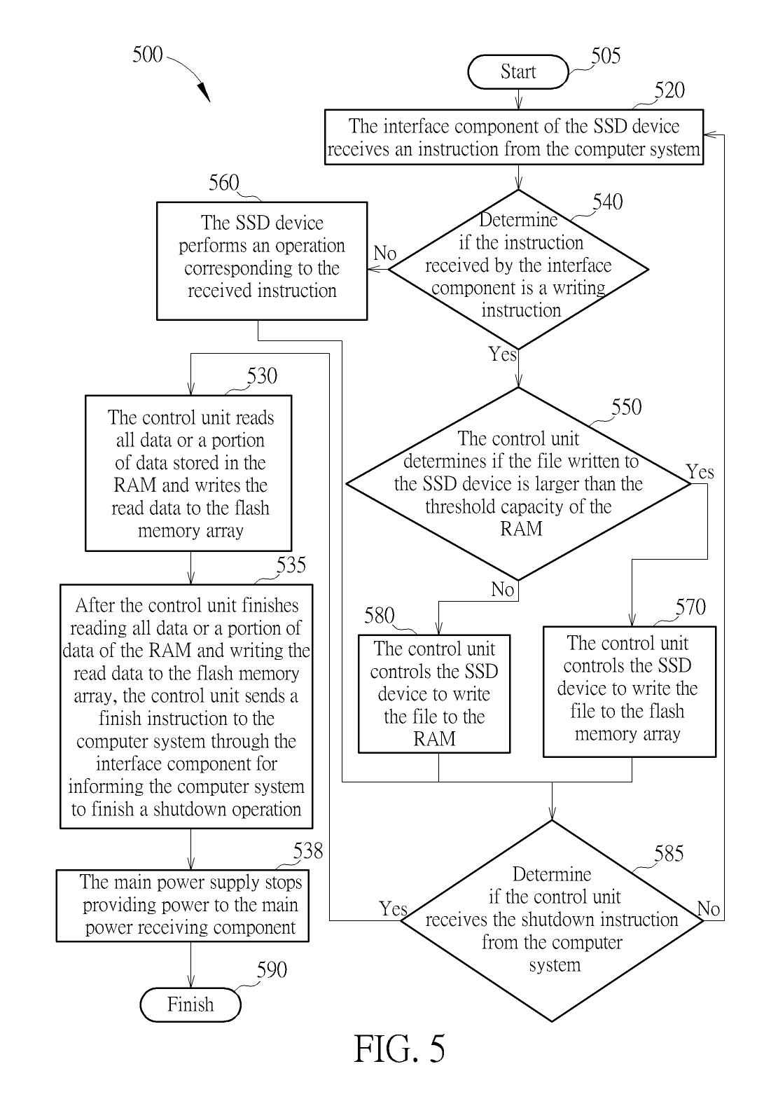

FIG. 5 illustrates an SSD device control method 500 corresponding to the SSD device 400 of FIG. 4. The method 500 includes the following steps:

Step 505: start;

Step 520: the interface component 140 of the SSD device 400 receives an instruction from the computer system 199; enter step 540;

Step 540: determine if the instruction received by the interface component 140 is a writing instruction I_{write}. If yes, enter step 550; if no, enter step 560;

Step 550: the control unit 130 determines if the file File1 written to the SSD device 400 is larger than the threshold capacity of the RAM 110. If yes, enter step 570; if no, enter step 580;

Step 560: the SSD device 100 performs an operation corresponding to the received instruction; enter step 585;

Step 570: the control unit 130 controls the SSD device 400 to write the file File1 to the flash memory array 120; enter step 585;

Step 580: the control unit 130 controls the SSD device 400 to write the file File1 to the RAM 110; enter step 585;

Step 585: determine if the control unit 130 receives the shutdown instruction I_{off} from the computer system 199. If yes, enter step 520; if no, enter step 530;

Step 330: the control unit 130 reads all data or a portion of data stored in the RAM 110 and writes the read data to the flash memory array 120; enter step 535;

Step 535: After the control unit finishes reading all data or a portion of data of the RAM 110 and writing the read data to the flash memory array 120, the control unit 130 sends a finish instruction I_{finish} to the computer system 199 through the interface component 140 for informing the computer system 199 to finish a shutdown operation;

Step 538: the main power supply 1501 stops providing power to the main power receiving component 150; enter step 590; and

Step 590: finish.

According to the embodiment corresponding to the method 500 shown in FIG. 5, if the SSD device 400 receives the shutdown instruction I_{off} in step 585, the control unit 130 reads data stored in the RAM 110 and writes the data to the flash memory array 120 in step 530. Before step 530 is finished, the control unit 130 does not send the finish instruction I_{finish} to the computer system 199. Without receiving the finish instruction I_{finish}, the computer system 199 does not finish the shutdown operation, and the main power supply 1501 keeps providing power to the SSD device 400 so that the control unit 130 is allowed to move data from the RAM 110 to the flash memory array 120 without interruption. After step 530 is performed, step 535 and step 538 are performed in sequence for the computer system 199 to finish the shutdown operation so that the main power supply 1501 stops providing power to the main power receiving component 150.

According to another embodiment of the present invention, a time period being long enough (e.g. 10 seconds) is required from when the SSD device 400 receives the shutdown instruction I_{off} to when the main power supply 1501 stops providing power to the main power receiving component 1501. The time period is for the control unit 130 to move all data or a portion of data stored in the RAM 110 to the flash memory array 120 without interruption caused by power failure.

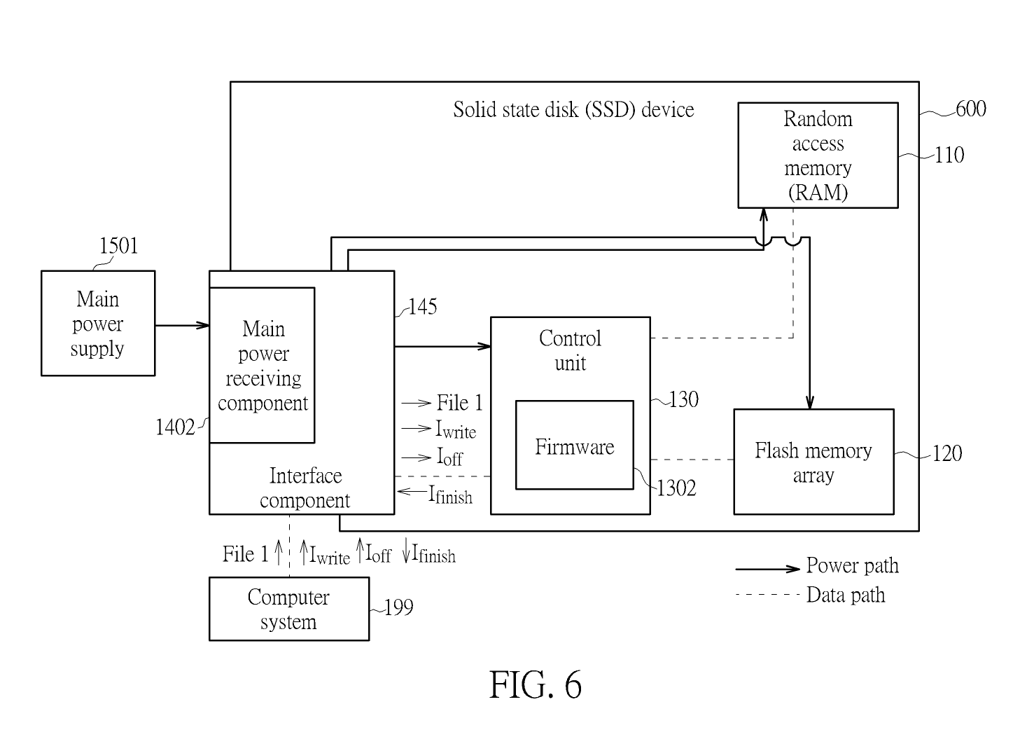

By using the SSD device 400 of FIG. 4 and the control method thereof such as the method 500 of FIG. 5, the number of times of writing data to the flash memory array 120 is decreased so that the lifetime of the SSD device is extended. Unlike the SSD devices 100 and 200, the SSD device 400 does not have the backup power supply 160, so the volume of the SSD device 400 is decreased. FIG. 6 illustrates an SSD device 600 according to another embodiment of the present invention. Like the SSD device 200, the main power receiving component 150 shown in FIG. 4 is allowed to be embedded in the interface component 140 to be like the interface component 145 of the SSD device 600 shown in FIG. 6. The operation of the SSD device 600 is similar to the SSD device 400, so it is not described repeatedly.

The SSD devices disclosed according to embodiments of the present invention are allowed to be embedded in electronics products such as portable computers, and the abovementioned backup power supply may be replaced by another power supply unit such as a rechargeable battery pack of a laptop computer. In other words, the SSD device disclosed by the present invention is not limited to be put in a case with a fixed shape, the technique disclosed by the present invention is also allowed to be implemented on a mainboard or in other electronic equipment.

By using the SSD devices 100, 200, 400 and 600, and the methods 300 and 500 disclosed by embodiments of the present invention, the number of times of writing data to the flash memory array is reduced by the hardware configuration. Unlike “wear-leveling technique” or “file comparison storage technique” disclosed by the prior art, the number of times of writing data to the flash memory array 120 is substantially decreased, and the type of the stored file is no more limited according to the present invention, therefore the lifetime of a flash memory array of an SSD device is well extended.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A solid state disk (SSD) device, comprising:
a random access memory (RAM);
a flash memory array;
a control unit coupled to the RAM and the flash memory array, the control unit comprising firmware configured to execute instructions of a computer system for accessing data of the RAM and the flash memory array;
an interface component coupled to the control unit and the computer system, and configured to receive the instructions of the computer system;
a main power receiving component coupled to the control unit, the interface component, the RAM and the flash memory array, and configured to receive power from a main power supply so as to provide power to the control unit, the interface component, the RAM and the flash memory array; and
a backup power supply coupled to the main power receiving component, the control unit, the RAM and the flash memory array, and configured to be charged by the main power supply when the main power receiving component receives power from the main power supply, and provide power to the control unit, the RAM and the flash memory array when the main power receiving component stops receiving power from the main power supply;
wherein when the interface component receives a writing instruction from the computer system, a file is written to the flash memory array if the file is larger than a threshold capacity of the RAM, otherwise the file is written to the RAM; and the control unit reads data stored in the RAM and writes the data stored in the RAM to the flash memory array when the main power supply stops providing power.

2. The SSD device of claim 1 wherein the main power receiving component is embedded in the interface component.

3. A solid state disk (SSD) device, comprising:
a random access memory (RAM);
a flash memory array;
a control unit coupled to the RAM and the flash memory array, comprising firmware configured to execute instructions of a computer system for accessing data of the RAM and the flash memory array;
an interface component coupled to the control unit and the computer system, and configured to receive the instructions of the computer system; and
a main power receiving component coupled to the control unit, the interface component, the RAM and the flash memory array, and configured to receive power from a main power supply so as to provide power to the control unit, the interface component, the RAM and the flash memory array;
wherein when the interface component receives a writing instruction from the computer system, a file is written to the flash memory array if the file is larger than a threshold capacity of the RAM, otherwise the file is written to the RAM; and a time period before the main power supply stops providing power, the computer system sends a shutdown instruction to the control unit through the interface component to enable the control unit to read data stored in the RAM and write the data stored in the RAM to the flash memory array.

4. The SSD device of claim 3 wherein the main power receiving component is embedded in the interface component.

5. A solid state disk (SSD) device control method, the SSD device comprising a random access memory (RAM), a flash memory array, an interface component, a main power receiving component and a backup power supply, the method comprising:
determining whether a file is larger than a threshold capacity of the RAM when writing the file to the SSD device through the interface component and the main power receiving component receives power from a main power supply;
writing the file to the RAM if the file is not larger than the threshold capacity; and
reading the file from the RAM and writing the file to the flash memory array when the main power supply stops providing power and the backup power supply provides power to the RAM and the flash memory array.

6. The method of claim 5, further comprising:
turning off the backup power supply after reading the file from the RAM and writing the file to the flash memory array.

7. The method of claim 5, wherein reading the file from the RAM and writing the file to the flash memory array is reading all data stored in the RAM and writing the all data stored in the RAM to the flash memory array.

8. The method of claim 5, wherein reading the file from the RAM and writing the file to the flash memory array is reading a portion of data stored in the RAM and writing the portion of data stored in the RAM to the flash memory array.

9. The method of claim 5, further comprising:
moving all data or part of data stored in the RAM to the flash memory array when the threshold capacity of the RAM is reduced to be smaller than a predetermined value.

10. A solid state disk (SSD) device control method, the SSD device comprising a random access memory (RAM), a flash memory array, an interface component and a main power receiving component, the method comprising:
determining whether a file is larger than a threshold capacity of the RAM when writing the file to the SSD device through the interface component and the main power receiving component receives power from a main power supply;
writing the file to the RAM if the file is not larger than the threshold capacity;
reading the file from the RAM and writing the file to the flash memory array when receiving a shutdown instruction through the interface component; and
the main power supply stopping providing power to the main power receiving component.

11. The method of claim 10, wherein the main power supply stopping providing power to the main power receiving component is performed at a time period after receiving the shutdown instruction.

12. The method of claim 10, further comprising:
sending a finish instruction after reading the file from the RAM and writing the file to the flash memory array;
wherein the main power supply stopping providing power to the main power receiving component is performed after receiving the finish instruction.

13. The method of claim 10, wherein reading the file from the RAM and writing the file to the flash memory array is reading all data stored in the RAM and writing the all data stored in the RAM to the flash memory array.

14. The method of claim 10, wherein reading the file from the RAM and writing the file to the flash memory array is reading a portion of data stored in the RAM and writing the portion of data stored in the RAM to the flash memory array.

15. The method of claim 10, further comprising:
moving all data or part of data stored in the RAM to the flash memory array when the threshold capacity of the RAM is reduced to be smaller than a predetermined value.

16. A solid state disk (SSD) device control method, the SSD device comprising a random access memory (RAM), a flash memory array, an interface component and a main power receiving component, the method comprising:
determining whether a file is larger than a threshold capacity of the RAM when writing the file to the SSD device through the interface component and the main power receiving component receives power from a main power supply; and
writing the file to the flash memory array if the file is larger than the threshold capacity.

17. The method of claim 16, further comprising:
moving all data or part of data stored in the RAM to the flash memory array when the threshold capacity of the RAM is reduced to be smaller than a predetermined value.
